(19) United States
(12) Patent Application Publication
(10) Pub. No.: US 2010/0125226 A1
(43) Pub. Date: May 20, 2010

(54) Breath trainer

(76) Inventor: Richard Kevin Hare, Fresno, CA (US)

Correspondence Address: Richard Kevin Hare, 2652 E. Lansing Way, Fresno, CA, 93726, US

(21) Appl. No.: 12/384,676

(22) Filed: Jun. 27, 2009

Related U.S. Application Data
(60) Provisional application No. 61/124,022, filed on Apr. 14, 2008.

(51) Int. Cl. A61H 1/00

(52) U.S. Cl. 601/46

(57) ABSTRACT

A portable battery operated user worn device that helps the user to learn to breathe more deeply and slowly, with the attendant benefits.

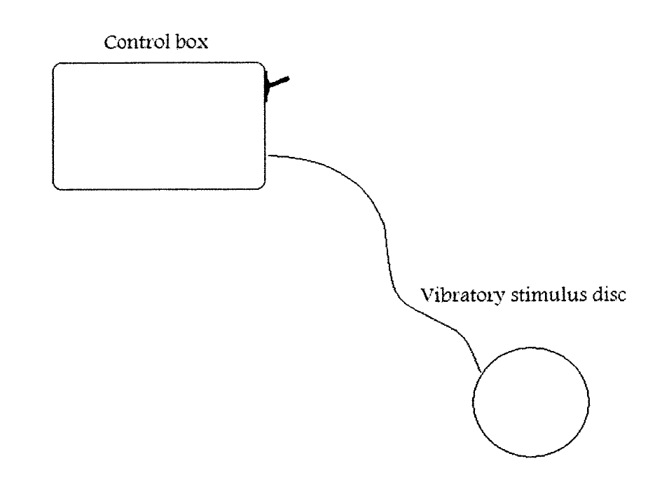

### BACKGROUND OF THE THE INVENTION

Taking a deep breath has long been recognized as useful in achieving a sense of calmness and well-being. How deep and how often one should practice this is not known but one could suspect that more frequent practice might increase the benefit. In our busy lives, it may not occur to us to practice. The presence of the Breath Trainer acts as a reminder to practice these skills.

### BRIEF SUMMARY OF THE INVENTION

The breath trainer acts as a means for a person to become aware of and modify their breathing pattern.

### DETAILED DESCRIPTION OF THE INVENTION

It is a portable external apparatus designed to deliver an intermittent vibratory stimulus to the abdominal region innervated by the thoracoabdominal intercostal and twelfth subcostal nerves. The device consists of a small control box containing circuitry that permits adjustable pulse duration and pulse intervals for the vibratory stimulus. The device is powered by a battery. The control box is connected by thin cable to the vibratory stimulus disc which can be attached to the abdomen by adhesive pad or held in place by the clothing. The device con be worn underneath clothing, allowing use during normal activities. The user controls operation of the device using an on/off switch. Upon feeling the vibration, the user either breathes in or breathes out, depending on what feels most natural at the time.

1. A simple, portable, easy to operate device that helps the user to practice deep breathing techniques in their everyday life.
